(19) United States
(12) Patent Application Publication
(10) Pub. No.: US 2015/0058708 A1
(43) Pub. Date: Feb. 26, 2015

(54) SYSTEMS AND METHODS OF CHARACTER DIALOG GENERATION

(71) Applicant: ADOBE SYSTEMS INCORPORATED, San Jose, CA (US)

(72) Inventor: Evtim Ivanov Georgiev, San Francisco, CA (US)

(73) Assignee: ADOBE SYSTEMS INCORPORATED, San Jose, CA (US)

(21) Appl. No.: 13/974,204

(22) Filed: Aug. 23, 2013

(51) Int. Cl. G06F 17/24

(52) U.S. Cl. CPC G06F 17/248
USPC 715/202

(57) ABSTRACT

Systems and methods of character dialog generation are provided. A face location for a person displayed within an image is detected. Metadata associated with the image is determined, where the metadata is specific to one or more characteristics of the image. A template relevant to the metadata is accessed, and the template and metadata are used to generate text. A display object with the text is provided, where the display object is displayed on the image over at least a portion of the face location detected.

### TECHNICAL FIELD

This disclosure relates generally to the technical fields of software and/or hardware technology and, in one example embodiment, to systems and methods of character dialog generation.

### BACKGROUND

The use of computing devices to create digital photo albums has become a popular way for people to organize photographs. The ease of sorting through photographs on a computing device has given way to many viewing and editing tools.

Although the utilization of computing devices to view, edit, and organize photographs may be helpful, current tools are generally limited. For example, while a user may add descriptions to portions of a digital photo album, such tools may require a user to manually enter these descriptions.

### BRIEF DESCRIPTION OF DRAWINGS

Embodiments are illustrated by way of example and not limitation in the figures of the accompanying drawings, in which like references indicate similar elements and in which:

FIG. 1 is an interface diagram illustrating an example user interface, in accordance with an example embodiment, for displaying a layout of images;

FIGS. 2A-2C are interface diagrams illustrating an example user interface, in accordance with an example embodiment, showing various display objects during character dialog generation;

FIG. 3A is a block diagram showing an example system architecture, in accordance with an example embodiment, within which a character dialog generation system and method are implemented;

FIG. 3B is a block diagram showing an example of a networked system, in accordance with an example embodiment, within which character dialog generation is implemented;

FIG. 4 is a block diagram showing example components of a character dialog generation system, in accordance with an example embodiment;

FIG. 5 is a flowchart showing an example method, in accordance with an example embodiment, of character dialog generation; and

FIG. 6 is a diagrammatic representation of a machine in the example form of a computer system within which a set of instructions may be executed to cause the machine to perform any one or more of the methodologies illustrated herein.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

Some portions of the detailed description which follow are presented in terms of algorithms or symbolic representations of operations on binary digital signals stored within a memory of a specific apparatus or special purpose computing device or platform. In the context of this particular specification, the term “specific apparatus” or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

As used herein, a “document” or “an electronic document” refers to electronic media content that is accessible by computer technology. For example, a document can be a file that is not an executable file or a system file and includes data for use by a computer program. An example of a document includes a single or multiple files that are accessible by and/or associated with electronic document processing applications such as word processing applications, document viewers, email applications, presentation applications, spreadsheet applications, diagramming applications, graphic editors, graphic viewers, enterprise applications, web design applications, and other applications. Therefore, as explained in more detail below, a document may be composed of alphanumeric texts, symbols, images, videos, sounds, and other data. It should be appreciated that a document can have a variety of file formats that, for example, may be identified by data within a document and/or by the filename extension. Examples of file formats that may be associated with a document include Adobe Portable Document Format (PDF), Microsoft DOC format, Hypertext Markup Language (HTML) format, Extensible Markup Language (XML) format, Microsoft XLS format, Cascading Style Sheet (CSS) format, Tag Image File Format (TIFF), Rich Text Format (RTF), Report File Format (RPT), and the like.

Example methods and systems are described that provide character dialog generation. In an example embodiment, the character dialog is generated at least initially without human intervention. The character dialog that is generated may be relevant to the content and/or characteristics of one or more images. For example, a display object, such as a speech bubble, may be automatically generated for an image displaying a person, and the display object may contain text that is relevant to the image. The text may be generated using metadata associated with any characteristics of the image, such as metadata captured when the image was taken, metadata obtained from a third-party website, metadata that is generated based on information within the image, and the like. Examples of metadata related to characteristics of an image may include a timestamp, a geographical location, photo album information, information associated with a detectable face or other object in the image, user information associated with people in the image, comment information from user comments about the image, and the like. The user's computing device may obtain metadata from a third-party website when the user's computing device is in communication with the third-party website using a direct connection or over a network, which may be any suitable network. In various embodiments, the computing device may be a mobile phone, a tablet computer, a desktop computer, or any other computing device configured to perform the methodologies described herein. One or more portions of the network may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Face detection may be used to determine whether an image contains one or more people, the location of a person's face, the size of the person's face, and the like. When a face is detected, a display object (e.g., a speech bubble) may be generated automatically at or near the location of the detected face. For example, the speech bubble may be positioned adjacent to the face with a terminal region extending towards a mouth of the face. Accordingly, in an example embodiment, various features of the face may be determined. In an example embodiment, the various features of the face may be determined. In an example embodiment, the display object may contain text that is relevant to the contents of the image. The relevant text may be generated using metadata associated with the image. For example, if the metadata is a timestamp that indicates that the image was taken in the morning, the text may be relevant to that particular time of day (e.g., “Good morning!”). In another example, if the metadata is a user identifier identifying a particular user (e.g., John Smith) of a third-party website (e.g., a social networking site), information associated with that user may be obtained from the third-party website, and that information may be used to generate text relevant to that user (e.g., “Good morning, John!”). The text may be editable by a user to further personalize the display object.

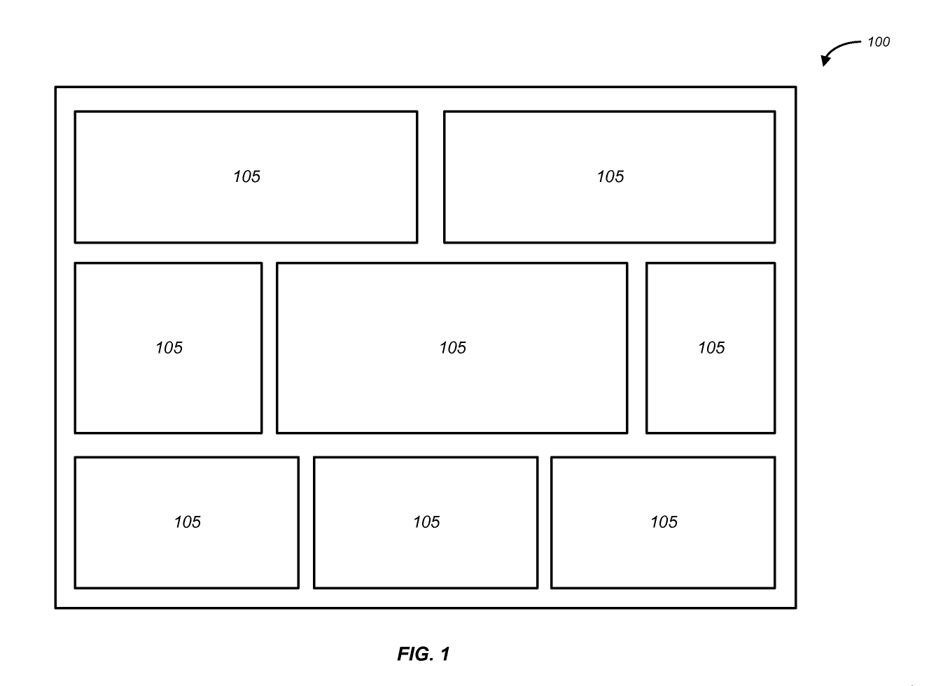

FIG. 1 is an interface diagram illustrating an example user interface 100, in accordance with an example embodiment, for displaying a layout of images 105. The user interface 100 may include various controls to allow a user to view, edit, organize, and/or arrange the images 105. The images 105 may be arranged by a user in any manner and/or configuration. For example, the number of images, the location of the images displayed in the user interface 100, the orientation of the images, and the like may be arranged in any manner. The images 105 may be images stored on a computing device displaying the images 105 and/or accessed by the computing device (e.g., from a storage device external to the computing device). In some embodiments, the images 105 may be accessed from a third-party website using a network. In an example embodiment, the methods and systems described herein are implemented using cloud-based technology. A user may select the images the user for display through the user interface 100.

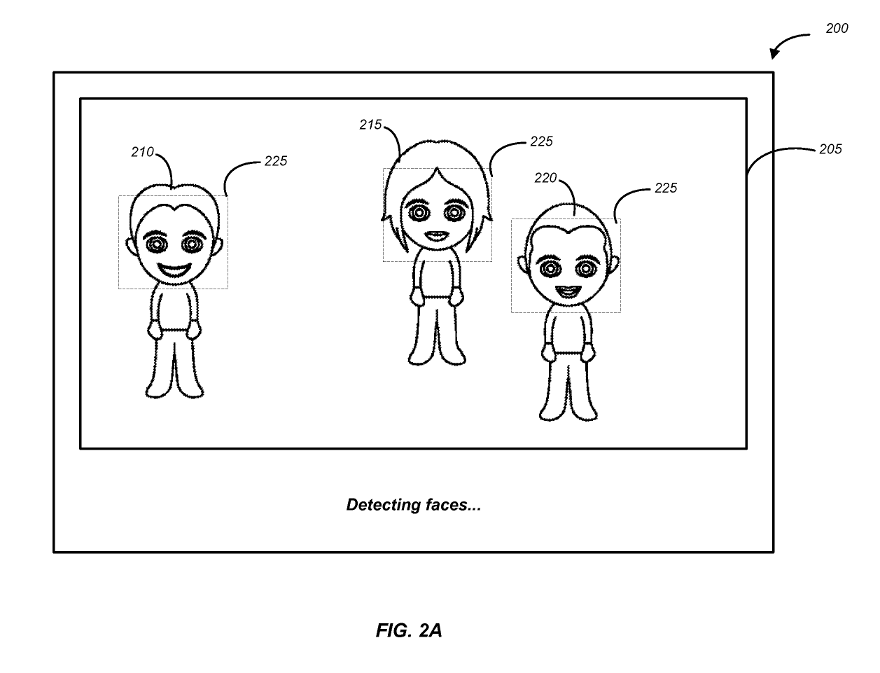

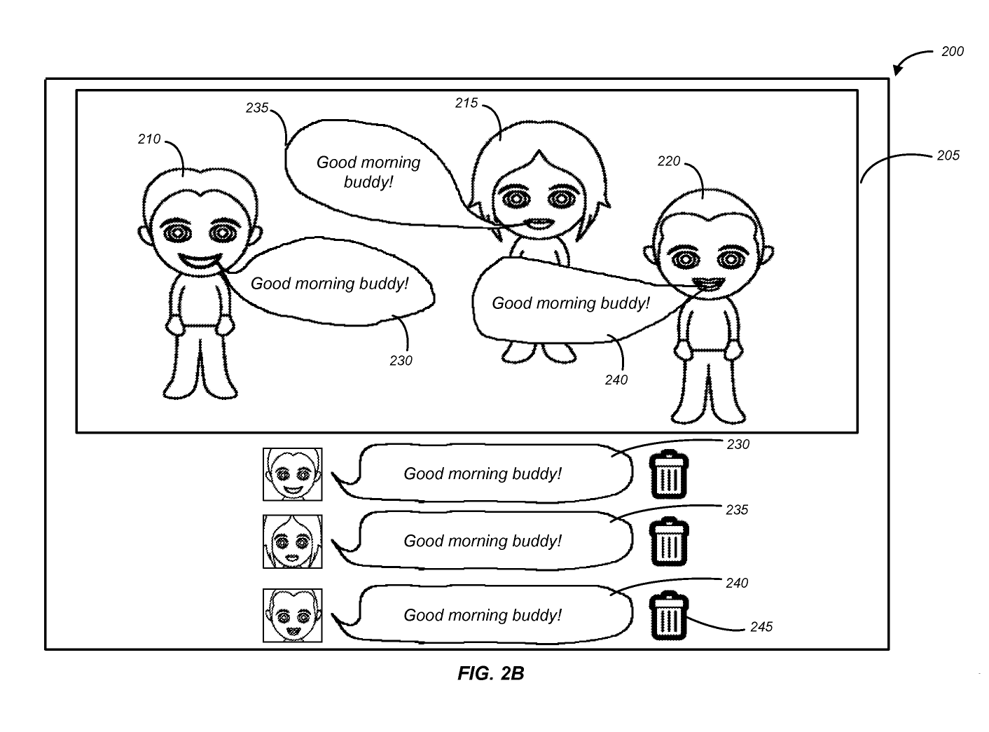

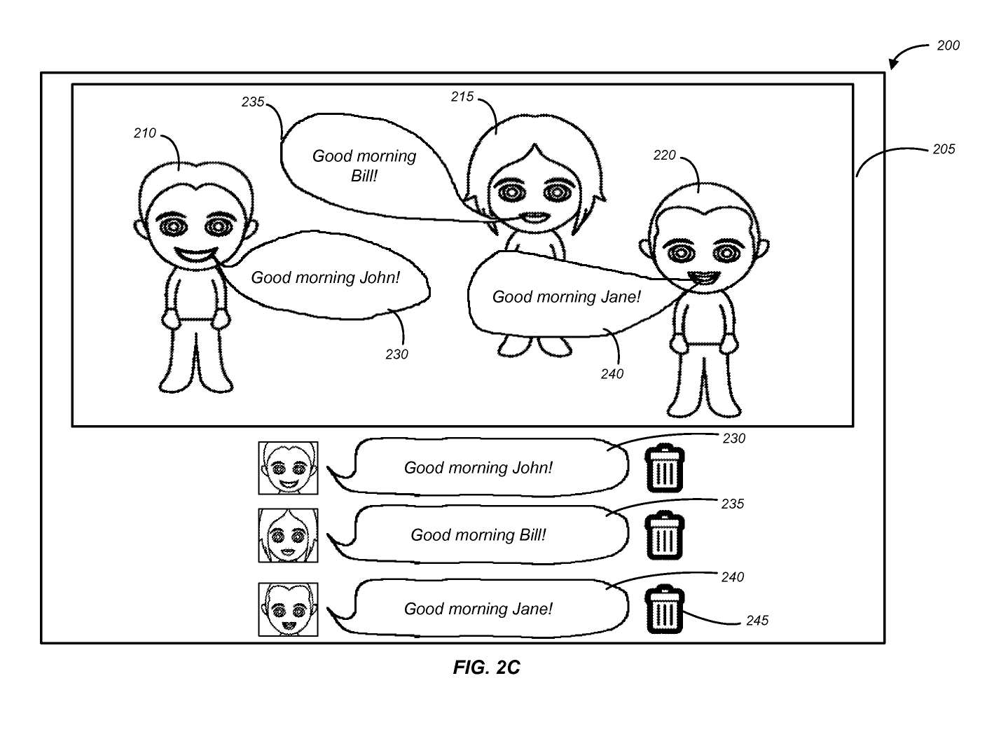

FIGS. 2A-2C are interface diagrams illustrating an example user interface, in accordance with an example embodiment, showing various display objects during character dialog generation. FIGS. 2A-2C show an image 205 (e.g., a photograph) selected by the user and displayed in a user interface 200. The image 205 may be an image that the user has selected from the images 105 shown in FIG. 1.

The image 205 is shown to include, merely by way of example, three people, person 210, person 215, and person 220. When the image 205 is displayed, face detection may be performed to determine whether a human person is displayed in the image 205. Each face that is included in the image 205 may be detected, as indicated by the rectangle 225 surrounding each face of person 210, person 215, and person 220. In some embodiments, face detection may be performed for non-humans as well (e.g., an animal).

Once the faces of each person in the image 205 have been detected, metadata associated with any characteristics of the image 205 may be accessed and used to automatically generate a character dialog relevant to the image 205. The character dialog may be text displayed within a display object (e.g., a speech bubble), where the text may give the appearance of a conversation between the people in the image 205. As previously described, the metadata used to generate the text may include metadata captured when the image 205 was taken, metadata obtained from a third-party website, metadata that is generated based on information within the image 205, and the like. Examples of metadata related to characteristics of an image may include a timestamp, a geographical location (e.g., city, country, place of business, etc.), photo album information (e.g., information obtained from Photoshop™ and/or Lightroom™ available from Adobe™), information associated with a detectable face or other object in the image, user information associated with people in the image, comment information from user comments about the image (e.g., from a social networking website), and the like.

FIG. 2B shows an example character dialog that may be automatically generated using any metadata associated with the image 205. For example, the metadata may include a timestamp associated with the image 205, indicating that the image 205 was taken in the morning. Text 230, text 235, and text 240 may reflect the metadata indicating the time of day (e.g., “Good morning buddy!”). Text 230, text 235, and text 240 may be editable by the user and/or deleted using the icon 245. For example, a user may edit text 230 to change “buddy” to a particular person's name.

FIG. 2C shows another example of character dialog that may be automatically generated using metadata associated with the image 205. For example, if the image 205 is associated with and/or accessed from a third-party website that is a social networking site, the image 105 may be associated with users of the social networking site, and those users may be tagged in the image 205 using user identifiers associated with the users. For example, the metadata may indicate that the person 210 is associated with a particular user identifier for a user of the social networking site. Any available metadata associated with that particular user may be accessed from the social networking site. For example, metadata indicating that the user identifier associated with person 210 is named Bill may be obtained and used to generate the text 240. Other examples of metadata obtainable from a third-party website include user information (e.g., identity of the owner of the image, identities of the people in the image, information about the people in the image, etc.), comments and/or keywords within comments made about the image on the third-party website, a geographical location, photo album information, and the like.

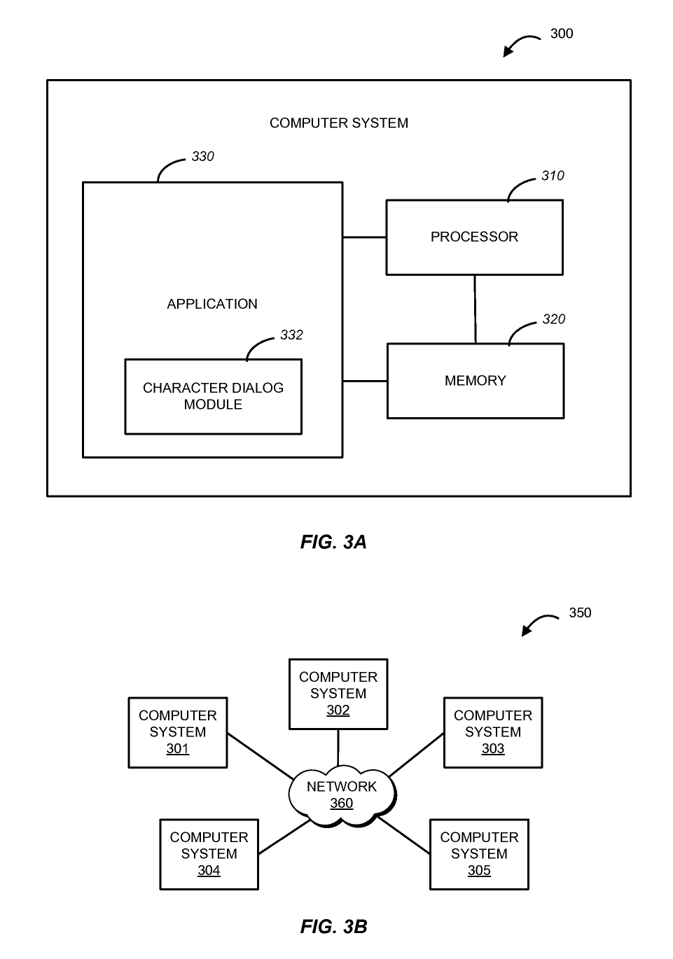

Referring to FIG. 3A, a block diagram shows an example system architecture, in accordance with an example embodiment, within which a character dialog generation system and method are implemented. The computer system 300 may comprise one or more processors 310, coupled to a memory 320, and an application 330. The application 330 may be any software application providing a user with the ability to view, edit, and arrange images (e.g., Photoshop™ and Lightroom™ available from Adobe™) and may include a character dialog module 332, in accordance with an example embodiment. The character dialog module 332 may be implemented as a module that is part of the application 330 or as a plug-in that can be utilized with the application 330 using various application program interfaces (APIs). The character dialog module 332, in one example embodiment, may be configured to automatically generate character dialogs for people displayed within an image. A user may select, modify, or otherwise process the automatically generated or suggested character dialogs. In an example embodiment, the computer system 300 is a mobile device (e.g., a smart phone, tablet computer, etc.) that is networked (e.g., to a cloud computing architecture) and configured to implement the methodologies described herein with reference to FIGS. 1 and 2A-2C.

FIG. 3B is a block diagram showing an example of a networked system 350, in accordance with an example embodiment, within which character dialog generation is implemented, for example in an automated manner at least initially without user intervention. The networked system 350 may include any number of computer systems similar to the computer system 300 of FIG. 3A. In the example of FIG. 3B, the example networked system 350 includes computer systems 301, 302, 303, 304, and 305, all communicatively coupled through the network 360. As previously described, the network 360 may be in any form, such as a LAN, WAN, a portion of the Internet, and/or the like. The network 360 may be used to communicate any images and metadata associated with the images. In some embodiments, one of the computer systems in networked system 350 may be a computer system for a social networking website.

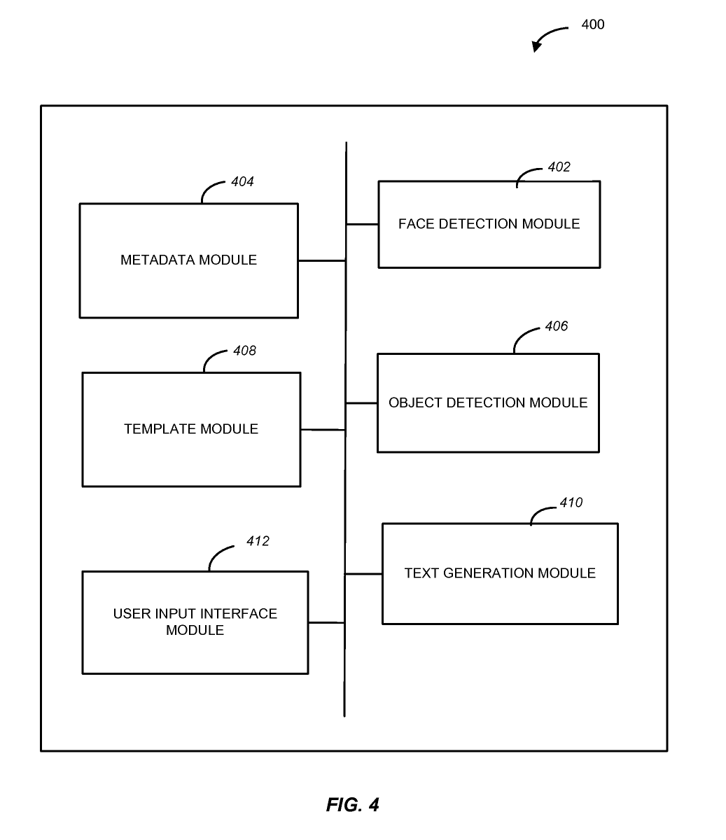

FIG. 4 is a block diagram showing example components of a character dialog generation system 400. The system 400 may automatically generate and provide character dialogs (e.g., on-the-fly) that may be associated with an application and may use functionality similar or the same as that provided by the character dialog module 332 of FIG. 3A. Each of the modules of the system 400 may be implemented utilizing at least one processor configured by instructions to perform the requisite functionality.

As shown in FIG. 4, the system 400 is shown by way of example to include a face detection module 402, a metadata module 404, an object detection module 406, a template module 408, a text generation module 410, and a user input interface module 412. It should be appreciated that one or more of the modules may be combined and that, in other example embodiments, further modules providing other functionality may be included.

The face detection module 402 may be a hardware-implemented module which may initiate, perform, manage, and control detection of faces in an image. The face detection module 402 may be performed using any suitable face detection techniques for determining the location, size, and/or any other facial recognition features of human faces in a digital image. Thus, in some embodiments, the face detection module 402 may also detect additional information about a face detected in the image, such as an orientation of the face (e.g., a vector indicating the direction of the face), a location of a mouth on the detected face, a facial expression on the face, and the like. For example, the orientation of a detected face and/or the location of the mouth on the detected face may be used to determine how to position the display object containing the relevant text, another person to whom the text is to be directed, and the like. A particular facial expression may be used to determine the relevant text that is to be generated. For example, if the face detection module 402 detects a smile on a detected face, the text generated may be relevant to a happy expression. It is to be appreciated that although the example embodiments described herein refer to character dialog generation of faces, in other embodiments recognition of other display objects may be performed and narrative or text associated with those objects may be generated.

The metadata module 404 may be a hardware-implemented module (e.g., using a processor and instructions) which may access, determine, store, manage, and control any metadata associated with one or more images. As described above, the metadata may be related to characteristics of an image and may include a timestamp, a geographical location, photo album information, information associated with a detectable face or other object in the image, user information associated with people in the image, comment information from user comments about the image, and the like. In some embodiments, the metadata module 404 may access metadata over a network (e.g., from a third-party website).

The object detection module 406 may be a hardware-implemented module (e.g., using a processor and instructions) which may initiate, perform, manage, and control detection of objects within an image such that metadata relevant to the object detected may be created and used for text generation. In an example embodiment, a background setting or other object in the image may also be detected. For example, the object detection module 406 may detect a beach scene. Metadata indicating the beach scene may be created and associated with the image, and the metadata may be used to generate text relevant to the beach scene. In an example embodiment, a database of reference scenes with various different reference dialogs may be provided. Accordingly, upon detecting a reference scene (or object in the image), the database may be accessed to obtain suggested narratives.

The template module 408 may be a hardware-implemented module (e.g., using a processor and instructions) which may store, manage, access, and control templates that may be used to generate text relevant to an image. A template may be a pre-defined set of text with metadata placeholders into which corresponding available metadata may be inserted. For example, a template that may generate the text “Good morning Bill!” may be stored as “Good_time_of_day_, _character_name_!”, where _time_of_day_ may be a placeholder for metadata associated with the time of day (e.g., morning) and _character_name_ may be a place holder for metadata associated with a relevant user's name. In some embodiments, if a particular metadata is unknown, a default generic term may be inserted in the placeholder. For example, if the _character_name_ is unknown, the term “buddy” may be inserted in the placeholder.

The template module 408 may store templates in an organized manner such that a template relevant to the available metadata may be accessed. For example, the template module 408 may organize templates based on types of templates, such as whether the template text includes an exclamation, regular speech, includes user information, and the like.

The text generation module 410 may be a hardware-implemented module (e.g., using a processor and instructions) which may initiate, manage, and control generation of text relevant to available metadata associated with an image. The text generation module 410 may use the available metadata and a template relevant to the available metadata to generate text that may be displayed within a display object, such as a speech bubble. In some embodiments, there may be more than one template relevant to the available metadata. In this case, the template may be chosen based on any suitable criteria. For example, the template chosen may be the template most relevant to the available metadata (e.g., the template containing the most placeholders for available metadata). In another example, the metadata may be organized based on importance, and the template chosen may be the template containing the most important available metadata.

The user input interface module 412 may be a hardware-implemented module (e.g., using a processor and instructions) which may receive and process user inputs from a user. For example, the user input interface module 412 may receive a user input indicating a request to edit or delete text, add a display object, and the like.

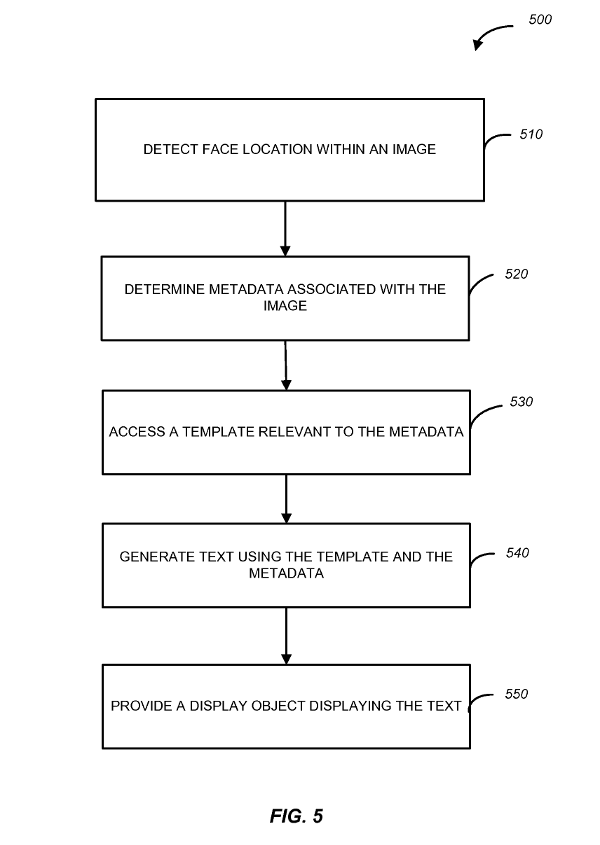

FIG. 5 is a flowchart showing an example method 500, in accordance with an example embodiment, of character dialog generation. The method 500 may be performed using the various modules of the system 400 shown in FIG. 4 and, accordingly, is described merely by example with reference thereto.

In operation 510, the face detection module 402 may detect a face location within an image. As described above, the face detection module 402 may detect the location of a face, the size of the face, the orientation of the face, a location of a mouth on the detected face, a facial expression on the face, and the like.

Thereafter, the metadata module 404 may determine metadata associated with the image (see operation 520). The metadata may be specific to one or more characteristics of the image, including a timestamp, a geographical location, photo album information, information associated with a detectable face or other object in the image, user information associated with people in the image, comment information from user comments about the image, and the like.

As shown in operation 530, the template module 408 may access a template relevant to the metadata. As described above, the template may include pre-defined text with placeholders for particular types of metadata. The template accessed may be based on the available metadata and/or available default terms for metadata that may be unavailable.

In operation 540, the text generation module 410 may generate text using the template and the metadata. The text may be generated by inserting the metadata into the appropriate placeholders in the template.

After the text has been generated automatically, the text generation module 410 may provide a display object displaying the text (see operation 550). The display object may be provided to the user's computing device in any suitable manner. For example, the display object may be a speech bubble displaying the text, and the speech bubble orientation may be based on a detected mouth location in the image. The speech bubble may be displayed in any manner and may be moved via a user input made by a user (e.g., touchscreen).

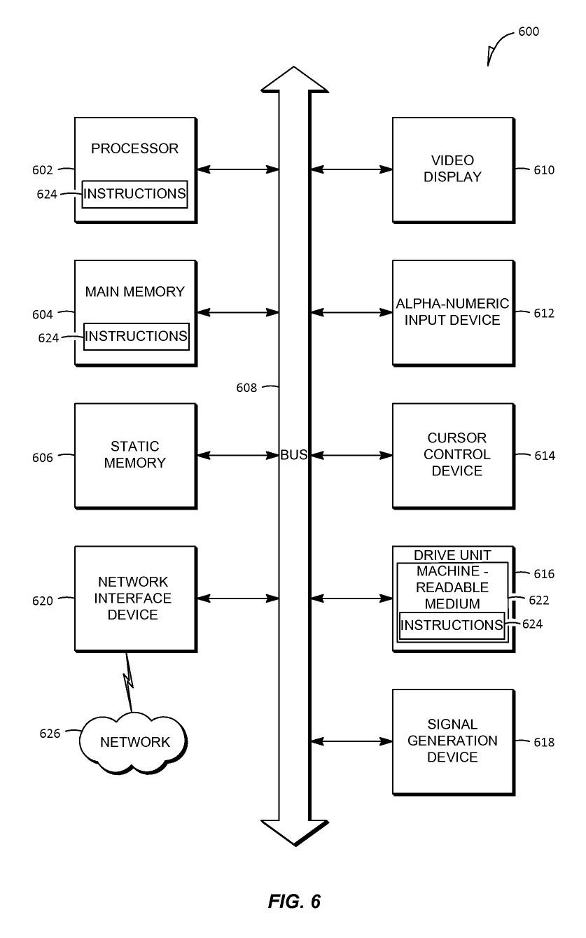

FIG. 6 is a diagrammatic representation of a machine in the example form of a computer system 600 within which may be executed a set of instructions 624 for causing the machine to perform any one or more of the methodologies related to character dialog generation. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a non-transitory machine-readable storage medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media.

The instructions 624 may further be transmitted or received over a network 626 via the network interface device 620 utilizing any one of a number of well-known transfer protocols (e.g., Hyper Text Transfer Protocol (HTTP)).

While the non-transitory machine-readable storage medium 622 is shown in an example embodiment to be a single medium, the term “machine-readable storage medium” should be taken to include a single medium or multiple media (e.g., a centralized or distributed database, and/or associated caches and servers) that store the one or more sets of instructions 624. The term “machine-readable storage medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable storage medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, methods and systems for character dialog generation have been described. Although the inventive subject matter has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented method, comprising:
detecting a face location of a face of a person within an image being displayed using a computing device;
determining, by the computing device, metadata associated with the image, the metadata being specific to one or more characteristics of the image;
accessing, by the computing device, a template relevant to the metadata;
generating, by the computing device, text using the template and the metadata; and
providing, by the computing device, a display object displaying the text, the display object being displayed on the image over at least a portion of the face location.

2. The computer-implemented method of claim 1, wherein the metadata includes at least one of the following: a timestamp associated with the image, a geographical location associated with the image, album information associated with the image, comment information associated with a comment about the image, and user information associated with one or more users identified within the image.

3. The computer-implemented method of claim 1, further comprising:
accessing the metadata over a network from a third-party website.

4. The computer-implemented method of claim 3, further comprising:
identifying the person within the image using the third-party website; and
accessing user information associated with the person, the metadata including the user information.

5. The computer-implemented method of claim 1, wherein the template includes pre-determined text with a placeholder, the metadata being inserted into the placeholder.

6. The computer-implemented method of claim 1, wherein accessing the template relevant to the metadata includes accessing the template from a set of relevant templates, the template being ranked highest within the set of relevant templates.

7. The computer-implemented method of claim 1, further comprising:
detecting face information associated with the face of the person within the image, the face information including at least one of the following: a facial expression of the person, a direction of the face of the person, and a location of a mouth of the person,
wherein the generating of the text or the providing of the display object is performed based on the face information.

8. The computer-implemented method of claim 1, further comprising:
detecting an object being displayed within the image,
wherein determining the metadata includes determining object characteristics associated with the object.

9. The computer implemented method of claim 1, further comprising:
sorting the metadata based on one or more types of data within the metadata.

10. A computing device, comprising:
a hardware-implemented face detection module configured to detect a face location of a face of a person within an image being displayed using the computing device;
a hardware-implemented metadata module configured to determine metadata associated with the image, the metadata being specific to one or more characteristics of the image;
a hardware-implemented template module configured to access a template relevant to the metadata; and
a hardware-implemented text generation module configured to:
generate text using the template and the metadata; and
provide a display object displaying the text, the display object being displayed on the image over at least a portion of the face location.

11. The computing device of claim 10, wherein the metadata includes at least one of the following: a timestamp associated with the image, a geographical location associated with the image, album information associated with the image, comment information associated with a comment about the image, and user information associated with one or more users identified within the image.

12. The computing device of claim 10, wherein the hardware-implemented metadata module is further configured to access the metadata over a network from a third-party website.

13. The computing device of claim 12, wherein the hardware-implemented metadata module is further configured to identify the person within the image using the third-party website and access user information associated with the person, the metadata including the user information.

14. The computing device of claim 10, wherein the template includes pre-determined text with a placeholder, the metadata being inserted into the placeholder.

15. The computing device of claim 10, wherein accessing the template relevant to the metadata includes accessing the template from a set of relevant templates, the template being ranked highest within the set of relevant templates.

16. The computing device of claim 10, wherein the hardware-implemented face detection module is further configured to detect face information associated with the face of the person within the image, the face information including at least one of the following: a facial expression of the person, a direction of the face of the person, and a location of a mouth of the person,
wherein the generating of the text or the providing of the display object is performed based on the face information.

17. The computing device of claim 10, further comprising:
a hardware-implemented object detection module configured to detect an object being displayed within the image,
wherein determining the metadata includes determining object characteristics associated with the object.

18. A non-transitory machine-readable storage medium having instructions which, when executed by one or more processors, cause the one or more processors to perform operations, comprising:
detecting a face location of a face of a person within an image being displayed using a computing device;
determining metadata associated with the image, the metadata being specific to one or more characteristics of the image;
accessing a template relevant to the metadata;
generating text using the template and the metadata; and
providing a display object displaying the text, the display object being displayed on the image over at least a portion of the face location.

19. The non-transitory machine-readable storage medium of claim 18, wherein the metadata includes at least one of the following: a timestamp associated with the image, a geographical location associated with the image, album information associated with the image, comment information associated with a comment about the image, and user information associated with one or more users identified within the image.

20. The non-transitory machine-readable storage medium of claim 18, wherein the instructions cause the one or more processors to perform further operations comprising:
detecting face information associated with the face of the person within the image, the face information including at least one of the following: a facial expression of the person, a direction of the face of the person, and a location of a mouth of the person,
wherein the generating of the text or the providing of the display object is performed based on the face information.

21. The non-transitory machine-readable storage medium of claim 18, wherein the instructions cause the one or more processors to perform further operations comprising:
detecting an object being displayed within the image,
wherein determining the metadata includes determining object characteristics associated with the object.
